(19) United States
(12) Patent Application Publication
(10) Pub. No.: US 2020/0151014 A1
(43) Pub. Date: May 14, 2020

(54) METHODS AND SYSTEMS FOR FORECASTING UPCOMING RESOURCE REQUIREMENT

(71) Applicant: SOLECULAR, INC., Sunnyvale, CA (US)

(72) Inventors: Sridhar SUKHI, Woodside, CA (US); Alex BAIN, Belmont, CA (US)

(21) Appl. No.: 16/679,171

(22) Filed: Nov. 9, 2019

Related U.S. Application Data
(60) Provisional application No. 62/758,479, filed on Nov. 9, 2018.

(51) Int. Cl. G06F 9/50; G06F 11/34; G06N 3/04

(52) U.S. Cl. CPC G06F 9/5011; G06F 9/505; G06F 2209/5019; G06F 11/3433; G06N 3/04; G06F 11/3442

(57) ABSTRACT

Methods and systems for forecasting upcoming values of time series are disclosed. A method includes receiving a time series data associated with a task to be managed by a managing agent at a regular interval of time. The method includes extracting one or more calendar-based features from a time series database table. The time series database table is prepared from the received time series data. The method includes processing the one or more calendar-based features and the time series data to generate one or more machine learning features. The method further includes developing a neural network forecasting model based on the one or more machine learning features using a neural network application.

### TECHNICAL FIELD

Embodiments of the disclosure relate generally to a field of forecasting future values of a time series that are directly or indirectly related to human activity including schedules and, more particularly to, methods and systems for forecasting upcoming resource requirement for a managing agent managing a task. Examples of the managing agent include, but are not limited to, data centers, electrical grids, site video surveillance system, and traffic management system.

### BACKGROUND

A resource can be anything from people to machinery. The management of resource is a critical thing for every industry and every industry has to find the best way to minimize its resource cost and enhance profits. For example, in large scale data centers that include thousands of servers and routers, resource management is critical for efficient operation. The data centers also have to ensure that workloads and network packets are allocated with sufficient resources to obtain the desired quality of service (QoS). The problem is exacerbated at edge computing sites, which are resource-constrained environments at remote locations with poor network connectivity in some cases. The edge computing sites typically are thousands in number and each edge computing site typically includes a small number of servers, storage, and network switches. Examples of edge computing sites include, but are not limited to, cell towers, retail outlets, and industrial locations.

Determining computer resource requirements in advance helps to proactively control resources in data centers and edge sites which leads to benefits, such as improved service performance, the ability to host more workloads, and power savings. However, the prediction of the computer resource requirements is not accurate at several instances. Underestimating the required computer resources may result in poor performance, such as high latency or low throughput. On the other hand, overestimating the required computer resources results in resource wastage. Hence, it is mandatory to forecast the resources accurately for the operational efficiency of an organization. In order to effectively adapt resource allocations, prediction methods are required to forecast the amount of resources needed in advance and make allocations accordingly. The predicted values in case of data center represent, for instance, amount of memory, CPU, network bandwidth, and disk I/O that must be allocated based on upcoming workload needs. For example, consider that there is a large upcoming computational operation that will occupy half of all computing resources (memory and CPU) of a group of servers in five minutes and this operation needs to be finished in one hour. At that specific time, over half of all resources are allocated for other operations which means more resources need to be provisioned to adapt to such a workload.

Currently, several methods are used to build models of resource consumption such as memory, CPU, network, disk I/O, electrical power loads, and road traffic. Based on these models, future workload resource usage is predicted, and the accuracy of prediction is assessed.

In another case of electrical grids, including micro grids, they have the responsibility to accurately match demand with supply of power (resource). Supply includes electricity generation and distribution. Some types of power generation can be scaled up and down quickly, while other types have longer response times. In addition, modern grids leverage distributed energy resources (DERs), including energy storage and loads that can be time-shifted. DERs can react to grid signals. Having accurate resource demand forecasts allows a grid operator's system to decide how to adjust generation as well as DERs.

Generally, in electrical grids, energy storage is a key for addressing the intermittent nature of some renewable energy sources. For example, if demand is expected to peak in the next few hours and there is excess solar generation now, the grid can store the excess energy in batteries or request DERs to increase load. If the demand is expected to fall in the next few hours relative to renewable generation, the grid can supply stored energy from batteries and be ready for excess generation. Accurate forecasts of resources i.e. power demand and supply are keys to optimize the grid. In an embodiment, the demand in an electrical grid is tied to a combination of weather as well as human behaviour.

In another example case of site video surveillance systems which are increasingly becoming connected systems, processing video data into quantitative time series metrics (say, level and type of activity) allows for distinguishing normal happenings at a site from abnormal activity at any given time of day, week, month, etc. So, accurate time-series forecasts can be used to set the normal pattern for future times, which allows computationally flagging anomalous activities.

In another example scenario of road traffic which follows daily, weekly, seasonal, and holiday patterns connected with a calendar in use in a given geography, having long-term forecasts of peaks and troughs in traffic will help a managing agency in planning roadway expansions, public transit, and carpool policies.

In the light of the above discussion, there is a need for automated methods and systems that efficiently forecast upcoming values of time series associated with calendar cycles in various fields which will help in forecasting resource requirement of that particular field.

### SUMMARY

Various embodiments of the present disclosure provide methods and systems for forecasting resource requirements for a managing agent managing a task based on various time series measurements that are observed related with the task.

In an embodiment, a method is disclosed. The method includes receiving a time series data associated with a task to be managed by a managing agent at a regular interval of time. The method includes extracting one or more calendar-based features from a time series database table. The time series database table is prepared from the received time series data. The method includes processing the one or more calendar-based features and the time series data to generate one or more machine learning features. The method further includes developing a neural network forecasting model based on the one or more machine learning features using a neural network application.

In another embodiment, a server system is disclosed. The server system includes a memory to store instructions and a processor to execute the stored instructions in the memory and thereby cause the server system to receive a time series data associated with a task to be managed by a managing agent at a regular interval of time. The server system is further caused to extract one or more calendar-based features from a time series database table. The time series database table is prepared from the received time series data. The server system is further caused to process the one or more calendar-based features and the time series data to generate one or more machine learning features. The server system is further caused to develop a neural network forecasting model based on the one or more machine learning features using a neural network application.

In yet another embodiment, a system is disclosed. The system includes a database, a user interface (UI) module, a managing agent management module, a task management module, a time series metric forecasting engine and a processing module. The database is configured to store time series data associated with a managing agent of one or more managing agents. The UI module is in communication with the database. The UI module is configured to present one or more UIs for facilitating forecast of upcoming values of time series for the managing agent. The managing agent management module is in communication with the UI module and the database. The managing agent management module is configured to manage the one or more managing agents that are enrolled with the system for determining forecast of resource requirement. The task management module is in communication with the UI module and the managing agent management module. The task management module is configured to manage a task to be managed by the managing agent. The time series metric forecasting engine is in communication with the managing agent management module and the task management module. The time series metric forecasting engine is configured to forecast upcoming values of time series for the managing agent. The processing module is configured to provide operating instructions to the UI module, the managing agent management module, the task management module and the time series metric forecasting engine.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an environment, where at least some example embodiments can be practiced;

FIG. 2 is a block diagram of a system for forecasting time-series metrics, in accordance with an example embodiment;

FIG. 3A is a flowchart illustrating a method for forecasting upcoming resource requirements in a data center, in accordance with an example embodiment;

FIG. 3B is a flowchart illustrating a method for forecasting upcoming power requirements in an electrical grid, in accordance with an example embodiment;

FIG. 4 is a schematic representation of a user interface depicting a time series database table maintained for the data center, in accordance with an example embodiment;

FIG. 5 is a schematic representation depicting importing of past resource usage values into a deep neural network, in accordance with an example embodiment;

FIG. 6 is a flowchart illustrating a method for forecasting upcoming values of a time series for a managing agent, in accordance with an example embodiment;

FIG. 7 is a schematic representation of a UI displayed on a display screen of a customer device displaying a graph depicting resource requirement forecast for an upcoming computing workload in the data center, in accordance with an example embodiment;

FIG. 8 is a block diagram of an electronic device capable of implementing the various embodiments of the present disclosure; and

FIG. 9 is a block diagram of a server system of FIG. 1 in which the optifunder application may be stored, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods and systems for forecasting upcoming values of a time series associated with a managing agent managing a task.

The method includes forecasting upcoming values of a time series associated with a managing agent which will help in forecasting upcoming resource requirement for the managing agent. A time series metric forecasting engine is utilized on a website/application maintained by the managing agent for facilitating viewing of the forecast of upcoming values of the time series for the managing agent.

For forecasting upcoming values of the time series, time series metric forecasting engine first receives a time series data associated with a task to be managed by a managing agent at a regular interval of time, such as after every 5 minutes. The time series data is basically a set of observations on one or more values that one or more variables take at a predefined interval. The one or more variables depend on the task to be managed by the managing agent. Once the time series data is received, the calendar-based features are extracted from a time series database table. The time series database table is prepared from the received time series data by organizing the received time series data in the time series database table maintained in a database. Further the calendar-based features and the time series data are processed to generate machine learning features which are subsequently fed into a neural network application. A neural network forecasting model is developed based on the one or more machine learning features using the neural network application. The developed neural network forecasting model is then used to generate the forecast of upcoming values of time series for the managing agent. The forecast of upcoming values of time series is further utilized to forecast upcoming resource requirement for the managing agent. Once the forecast is generated, the forecast can be viewed by accessing website/application maintained by the managing agent.

The term ‘managing agent’ refers to an organization, management or distribution center maintained by a person or a company which is involved in managing a task. The present disclosure is not intended to limit the scope of the invention as it is explained with reference to few specific cases, such as resource requirements of computing workloads in data centers and power requirement in electrical grid.

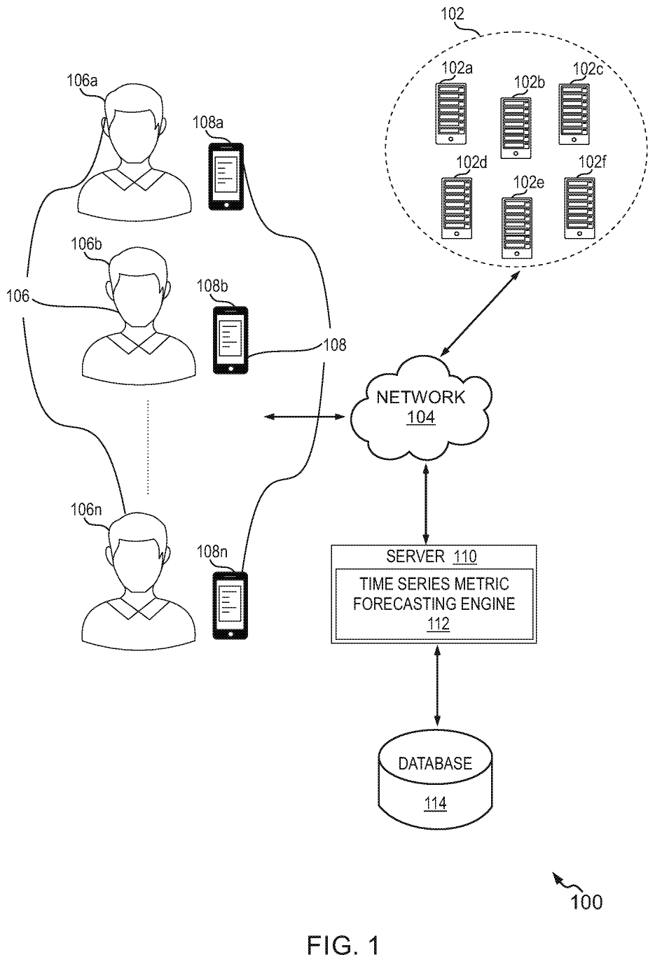

FIG. 1 is an illustration of an environment 100 where at least some example embodiments may be practiced. The environment 100 typically represents a business/organization environment. Specifically, the environment 100 includes IT infrastructure (hardware, software, network resources and services) of an IT enterprise. The IT infrastructure shown in FIG. 1 is independent of its location, for instance, it can be included in data centers, cloud sites and edge computing sites. The environment 100 described herein describes a data center as an exemplary location of IT infrastructure. It will be appreciated to those skilled in the art that any other suitable location of IT infrastructure may be referred in the following discussion.

The environment 100 includes a wireless communication network (e.g., a network 104) that connects entities such as, a data center 102, a plurality of customers 106a to 106n, and a server 110. A plurality of servers 102a to 102f is shown to be located in the data center 102. The customers 106a to 106n are depicted to be associated with electronic devices 108a to 108n (hereinafter referred to as ‘customer devices 108a to 108n’), respectively. It should be noted that the customers 106a to 106n are collectively referred as a customer 106 and the customer devices 108a to 108n are collectively referred as a customer device 108. The customer device 108 may be capable of being connected to a wireless communication network (such as the network 104). Examples of the customer device 108 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

A data center (e.g., the data center 102) is usually a facility composed of networked computers and storage that a business or organization may use to organize, process and store large amounts of data. Typically, the data center includes a plurality of elements such as servers (e.g., the servers 102a to 102f), storage subsystems, networking switches, routers, firewalls as well as cabling and physical racks that are used to organize and interconnect the IT equipment. The data center can be a warehouse-sized building, a server closet or a small container at a cell tower. In some embodiments, the data center may have thousands of servers or more. The servers (e.g., the servers 102a to 102f) in the data center refer to groups of computers that are specifically located in facilities geared for computing infrastructure. Such servers are often rack-mounted and used for non-interactive processing of computer programs.

The data center may also include adequate infrastructure such as power distribution and supplemental power subsystems including electrical switching, uninterruptible power supply (UPS) and generators to support uninterrupted functioning of the data center.

In data center, data is distributed to and from a server (e.g., the server 110) using network switches. Depending on the density of data, the data center may have one or more switches per rack. Besides IT equipment, the data center network connects servers, technology and infrastructure needed to support processes in the organization. Nowadays, data centers have become an integral component of a plurality of organizations. Further, the data center may have a plurality of monitoring systems to help operators in managing the working of the data center.

In at least one example embodiment, the customer device 108 is equipped with a time series metric forecasting engine 112 that facilitates forecasting of time-series metrics associated with calendar cycles in data center 102 which will help in forecasting of upcoming resource requirement of the data center 102. The customer device 108 may be any communication device having hardware components for enabling User Interfaces (UIs) which the customer 106 can utilize to access the network 104. In an embodiment, the customer device 108 may access the time series metric forecasting engine 112 to see forecast of upcoming resource requirement of the data center 102. Examples of the customer device 108 include, but are not limited to, a desktop computer, a personal computer (PC), a mobile phone, a tablet device, a personal digital assistant (PDAs), a smart phone, an ultra book, a notebook and a laptop. Examples of the user interface include, but are not limited to, a display screen, a keyboard, a mouse, a light pen, an appearance of desktop, a plurality of illuminated characters and a plurality of help messages.

The time series metric forecasting engine 112 is an application resting at the server 110. In an embodiment, the server 110 is configured to manage the time series metric forecasting engine 112 and communicate with device, such as the customer device 108 using the network 104. Examples of the network 104 include stand alone or a combination of a local area network (LAN), a wide area network (WAN), wireless, wired, any currently existing or to be developed network that can be used for communication. More specifically, an example of the network 104 can be the Internet which may be a combination of a plurality of networks. The time series metric forecasting engine 112 may be accessed through the web via the network 104. In an embodiment, time series metric forecasting engine 112 may be accessed through the web using Internet.

In at least one example embodiment, the time series metric forecasting engine 112 is configured to provide forecast of time-series metrics associated with calendar cycles of the data center 102 which will be further utilized to provide forecast of upcoming resource requirement of the data center 102.

A database 114 associated with the server 110 stores the data of the data center 102 and the stored data is accessible to any computing device (e.g., the customer device 108) associated with server 110 using the network 104. Typically, a request is sent from the customer device 108 to the data center 102 through the server 110. Similarly, the data is received by the customer 106 who operates the customer device 108 through the server 110. Each server of the servers 102a to 102f in the data center 102 executes at least one or perhaps a plurality of computing workloads (tasks) simultaneously (by executing a virtual machine or container associated with each workload).

The virtual machine refers to a technique of sharing the hardware of a single physical server among a plurality of simulated computers that run on that physical server. Containers are similar to virtual machines, but rely more on operating system of server and less on the physical hardware of the server to provide the effect of running a plurality of simulated computers on a single physical server. One of the most common uses of a virtual machine or a container is for non-interactive processing of a computer program in the data center 102, and thus it is assumed that the computing workloads (tasks) whose computing resource requirements are forecasted in the FIG. 1 disclosure are actually running as part of the virtual machine or the container.

In an example scenario, as shown in FIG. 1, a customer (e.g., the customer 106) may want to know the resource requirement of a data center (e.g., the data center 102) for an upcoming task to be managed so that the customer can allocate the resources efficiently. The customer may use a mobile device (e.g., the customer device 108) to access a website/application of an organization maintaining the data center using a network (e.g., the network 104). The website/application may rest at a server (e.g., the server 110) which includes a time series metric forecasting engine (e.g., the time series metric forecasting engine 112) for facilitating forecast of upcoming resource requirement of the data center.

For forecasting the upcoming resource requirement, the time series metric forecasting engine first collects time series data about the CPU, RAM, power utilization and computing workloads of the data center using the network. Once the time series data is collected, the time series data is organized in a time series database table available in a database (e.g., the database 114) in communication with the server. Once the time series data is organized in the time series database table, one or more calendar based features are extracted from the time series database table. The calendar based features are numeric components extracted from a timestamp of each measurement in the time series, such as a year, a month, a day of a year, a day of a month in a solar calendar (for example, in a Gregorian calendar), a day in a lunar month, a day of a month in a lunar calendar, a day of week, a week of month, an hour and a minute. The calendar based features are extracted to determine how data center resources are utilized in the past on specific calendar feature which will give an idea of the upcoming resource requirements. Further, the time series data and the one or more calendar based features are processed to develop a neural network forecasting model using a deep neural network application. The developed neural network forecasting model will generate a forecast of the upcoming computing resource requirements of the data center. The generated forecast will be displayed to the customer on his/her electronic device.

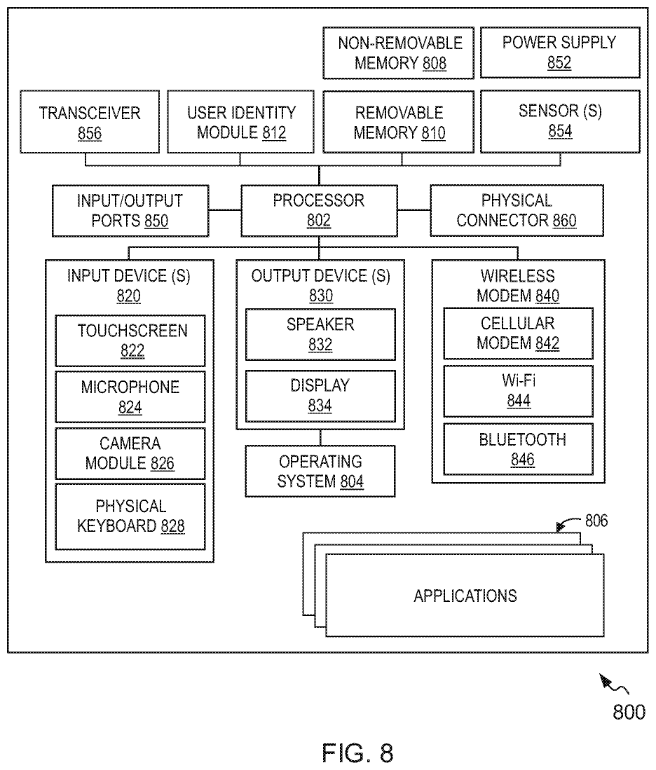

It is noted that the instructions (or the executable code) configuring the time series metric forecasting engine 112 are stored in a memory of the server 110, and the instructions are executed by a processor (for example, a single-core or a multi-core processor) included within the server 110, as is exemplarily shown with reference to FIG. 8. Accordingly, even though the various functionalities for providing forecast of upcoming resource requirement of the data center 102 are explained with reference to or being performed by the time series metric forecasting engine 112, it is understood that the processor in conjunction with the code in the memory is configured to execute the various tasks as enabled by the instructions of the time series metric forecasting engine 112.

It should be appreciated by those skilled in the art that FIG. 1 depicts the server 110 and computing devices, for instance customer device 108 in an oversimplified manner and a practical embodiment may include additional components and suitably configured processing logic to support known or conventional operating features that are not described in detail herein.

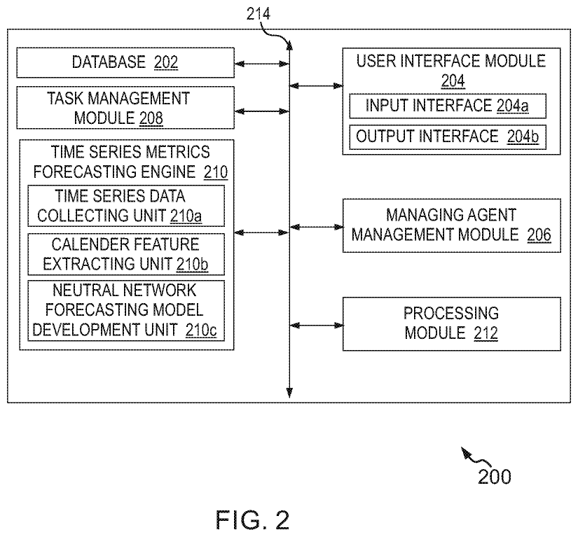

The various components of the time series metric forecasting engine 112 are further explained with reference to FIG. 2.

FIG. 2 is a block diagram of a system 200 for forecasting time-series metrics, in accordance with an example embodiment. The system 200 may be embodied in a server, such as the server 110 or an electronic device, such as, the customer device 108. The system 200 enables customer (e.g., the customer 106) to see the forecast of time-series metrics which is further utilized to determine the forecast of upcoming resource requirement for a managing agent managing a task.

In an embodiment, the system 200 includes a database 202, a user interface (UI) module 204, a managing agent management module 206, a task management module 208, a time series metric forecasting engine 210, a processing module 212 and a centralized circuit system 214. The time series metric forecasting engine 210 further includes a time series data collecting unit 210a, a calendar feature extracting unit 210b and a neural network forecasting model development unit 210c.

The database 202 is configured to store time series data associated with a managing agent of one or more managing agents using the system 200. The time series data is received from a system/server associated with the managing agent.

The user interface module 204 is in communication with the database 202. The user interface module 204 is configured to present one or more UIs for facilitating forecast of upcoming values of time series for the managing agent. The UI module 204 includes an input interface 204a and an output interface 204b. The input interface 204a is configured to receive data associated with the managing agent. The data includes information related with a task to be managed by the managing agent. Examples of the input interface 204a may include, but are not limited to, a keyboard, a mouse, a joystick, a keypad, a touch screen, soft keys, a floppy disk, a pen drive, a hard drive and the like. The output interface 204b is configured to display the forecast of upcoming values of time series for the managing agent which may be used to forecast the resource requirement for the managing agent. In an embodiment, the output interface 204b is configured to display a forecast of upcoming values of time series for the managing agent which may be used to distinguish a normal activity from an anomalous activity. Examples of the output interface 204b may include, but are not limited to, a display such as a light emitting diode (LED) display, a thin-film transistor (TFT) display, a liquid crystal display, an active-matrix organic light-emitting diode (AMOLED) display, and the like.

The managing agent management module 206 is in communication with the UI module 204 and the database 202. The managing agent management module 206 is configured to manage the one or more managing agents that are enrolled with the system 200 for generating forecast of upcoming values of time series for determining forecast of upcoming resource requirement. The managing agent management module 206 is configured to maintain information about each managing agent of the one or more managing agents. The information includes, but is not limited to, a managing agent name, a task performed by managing agent, a list of customers associated with the managing agent, data associated with the managing agent, and customer details. For example, in case the managing agent is a data center, the information will include data center name as managing agent name, resource allocation management as task performed by the managing agent, a plurality of persons that are responsible for allocating resources in data center as the list of customers associated with the managing agent, time series metric associated with the data center as data associated with the managing agent and authentication details of the plurality of persons that are responsible for allocating resources in data center as customer details. Examples of the managing agent may include, but are not limited to, data centers, electrical grids, traffic management systems, site video surveillance systems, social media management platforms, online transaction management systems and online gaming.

The task management module 208 is in communication with the UI module 204 and the managing agent management module 206. The task management module 208 is configured to manage a task to be managed by the managing agent. The task management module 208 is configured to maintain information about the task to be managed by the managing agent. The information includes, but is not limited to, a task id, a list of requirements, and a managing agent name.

The time series metric forecasting engine 210 is in communication with the managing agent management module 206 and the task management module 208. The time series metric forecasting engine 210 is configured to forecast upcoming values of the time series for the managing agent which may be further used to forecast upcoming resource requirement for the managing agent managing the task associated with them. The time series metric forecasting engine 210 includes the time series data collecting unit 210a, the calendar feature extracting unit 210b and the neural network forecasting model development unit 210c.

In an embodiment, the time series data collecting unit 210a is configured to collect time series data associated with the managing agent at a regular interval of time, such as after every 5 seconds or 10 seconds. The time series data depends on the managing agent. For example, in case of data center, the time series metrics may include CPU, RAM, network data and power utilization levels for each computing workload in data center, and, in case of an electrical grid, the time series data may include voltage, current and/or power measurements for each distributed energy resources (DERs) associated with the electrical grid.

The calendar feature extracting unit 210b is in communication with the time series data collecting unit 210a for extracting calendar based features from the time series data. In an embodiment, the calendar based features are average of the time series data values that are observed on some particular calendar feature. Examples of the calendar feature may include, but are not limited to, a year, a month, a day of a year, a day of a month, a day of a week, a weak of a month, an hour, and a night of a day. The calendar based features provide more direct correlation with resource usage cyclicality and rising and falling trends. Such direct correlations are much easier to learn by machine learning models such as deep neural networks, which translate to less computational overhead for forecasting as compared to brute-force methods.

The neural network forecasting model development unit 210c is in communication with the time series data collecting unit 210a and the calendar feature extracting unit 210b. The neural network forecasting model development unit 210c is configured to process the time series data and the calendar based features into one or more machine learning features. The neural network forecasting model development unit 210c is further configured to develop a neural network forecasting model from the one or more machine learning features for forecasting upcoming values of the time series for the managing agent. In an embodiment, the neural network forecasting model is generated using the deep neural network application.

In an embodiment, the processing module 212 is configured to send operating instructions to the database 202, the UI module 204, the managing agent management module 206, the task management module 208 and the time series metric forecasting engine 210 of the system 200 for operation of the components of the system 200.

The database 202, the UI module 204, the managing agent management module 206, the task management module 208, the time series metric forecasting engine 210 and the processing module 212 may be configured to communicate with each other via or through the centralized circuit system 214. The centralized circuit system 214 may be various devices configured to, among other things, provide or enable communication between the modules (202-212) of the system 200. In certain embodiments, the centralized circuit system 214 may be a central printed circuit board (PCB) such as a motherboard, a main board, a system board, or a logic board. The centralized circuit system 214 may also, or alternatively, include other printed circuit assemblies (PCAs) or communication channel media. In some embodiments, the centralized circuit system 214 may include appropriate storage interfaces to facilitate communication among the modules (202-212). Some examples of the storage interface may include, for example, an Advanced Technology Attachment (ATA) adapter, a Serial ATA (SATA) adapter, a Small Computer System Interface (SCSI) adapter, a RAID controller, a SAN adapter or a network adapter.

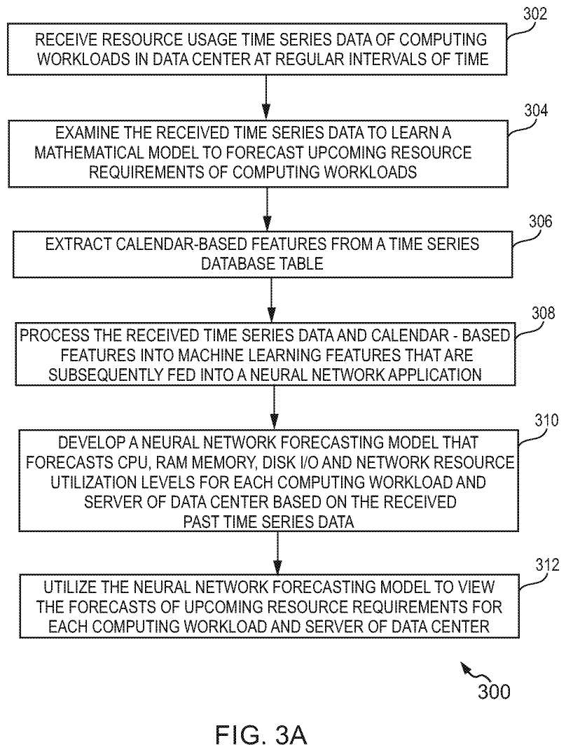

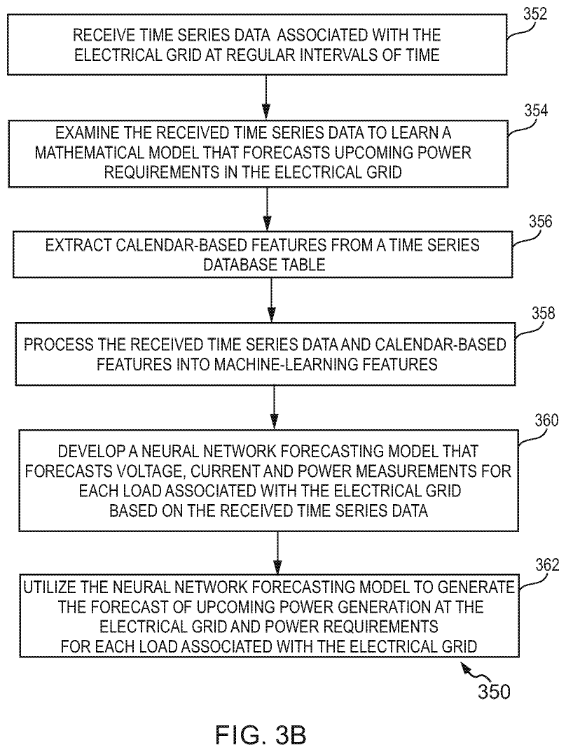

FIG. 3A is a flowchart illustrating a method 300 for forecasting upcoming computer resource requirements of computing workloads in a data center, in accordance with an example embodiment. The operations of the method 300 may be carried out by a server such as the server 110, the system 200 or the electronic device 108. The sequence of operations of the method 300 need not to be necessarily executed in the same order as they are presented. Further, one or more operations may be grouped together and performed in form of a single step, or one operation may have several sub-steps that may be performed in parallel or in sequential manner.

In the present disclosure, it is assumed that the data center is equipped with a group of servers (e.g., the servers 102a to 102f shown in FIG. 1). Additionally, it is also assumed that a group of computing workloads is executed on the group of servers. The computing workloads refer to non-interactive computer programs that run on servers in a data center, such as programs for handling scientific, operational, content distribution, or financial processing. Such computing workloads are often scheduled to run at regular periods (such as end-of-the-month financial programs) or even continuously in the servers.

At operation 302, a resource usage time series data of computing workloads in the data center are received at regular intervals of time. The time series is a sequence of numerical data points recorded at regular equally spaced time intervals, such as after every 5 seconds. The time series helps in identifying change of a data item that is being measured. Here, data depicting utilization of resources of the data center while performing a plurality of tasks is received. The data includes data points associated with CPU, RAM, network data and power utilization of the computing workloads. The received data may help in forecasting time series for the data center which will provide the upcoming resource requirement of the computing workloads in the data center.

In an embodiment, the forecasting of time series is a process of collecting data that occurs at regular time intervals (time series data) and then making a prediction (forecast) about the upcoming data that will appear in the near future. Basically, time series forecasting predicts future values based on previously observed values. It will be appreciated by those skilled in the art that the process of collection and aggregation of the time series data may be performed with any suitable computer technique known in the art.

At operation 304, the received time series data is examined to learn a mathematical model that forecasts upcoming resource requirements of computing workloads in the data center. The resource requirements refer to the amount of Central Processing Unit (CPU), Random Access Memory (RAM) and power required to execute a given set of computing workloads amongst a group of computer servers in the data center. The time series data examination is a statistical technique that deals with time series data. As described earlier, the time series data is a set of observations on the values that a variable takes at different times. In case of data centers, the variable is the computing resources. In other domains, there are corresponding time series of sensor measurements that pertain to that domain.

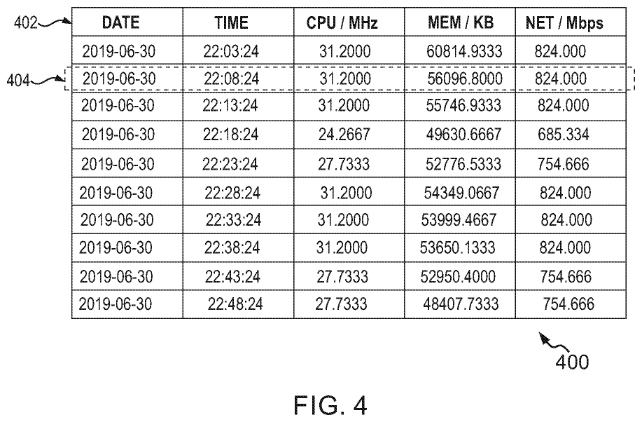

At operation 306, calendar-based features are extracted from a time series database table. The time series database table is prepared from the time series data that is received at the operation 302. The time series data is first organized into the time series database table maintained in a database (e.g., the database 114). In an embodiment, the time series database table includes one or more columns and one or more rows, where one or more columns represent the one or more variables and one or more rows represent the one or more values taken by the one or more variable. In the case of data centers, the variables represent the computing resources, such as CPU, RAM, network data and power utilization. The time series database table is further explained with reference to FIG. 4.

Once the time series data is organized in the time series database table, the values taken by the variables are extracted based on calendar features. Here, the values taken by the variables represent the calendar based features. The calendar based features are nothing but an average of the time series data collected on specific calendar feature, such as a year, a month, a day of a year, a day of a month, a day of week, a week of month, an hour and a minute. The calendar based features help in determining resource utilization cycles that the data center follows in the past which will help in determining the time series metric that the data center may follow in future.

At operation 308, the received time series data and calendar-based features are processed into machine-learning features. The time series data is processed into machine-learning features related to cyclically repeating trends in the time series data and growth/decline trends in the time series data. The cyclically repeating trends and growth/decline trends are determined based on the calendar-based features. The generated machine learning features are further imported into a neural network application which outputs a neural network forecasting model (discussed in operation 310). It will be appreciated by those skilled in the art that, any suitable neural network application may be used to perform the operations described herein.

After importing the machine learning features, it is determined whether a previously learnt time series of the data center already exists in the neural network application. If it is determined that the previously learnt time series already exists, the time series data is summarized into a recurring cycle, for example, a set of average values for each hour of the week (168 values in total) and compared with previously learnt time series. If a previously learnt time series is found to be similar with current time series data, the neural network learning process starts with the neural network weights (set of average values) for the previously learnt time series as this decreases number of epochs required to learn the new time series and create the neural network forecasting model.

At operation 310, the neural network forecasting model is developed that forecasts resource utilization levels, such as CPU, RAM and network bandwidth utilization levels for each computing workloads and servers of the data center based on the received time series data. These resources are provided herein only for example purposes and should not be considered limiting to the scope of the present disclosure, and different applications may utilize different resources depending upon the requirement of the applications. The neural network forecasting model is developed based on the machine learning features using the neural network application. The time series is summarized into a set of average values for a recurring cycle, for example each hour of the week (168 values total) and its neural network is stored along with the summary in the database. The stored summaries are used to optimize the learning rate (in number of epochs) for new incoming time series in operation 308. In an embodiment, the neural network application is a deep neural network application.

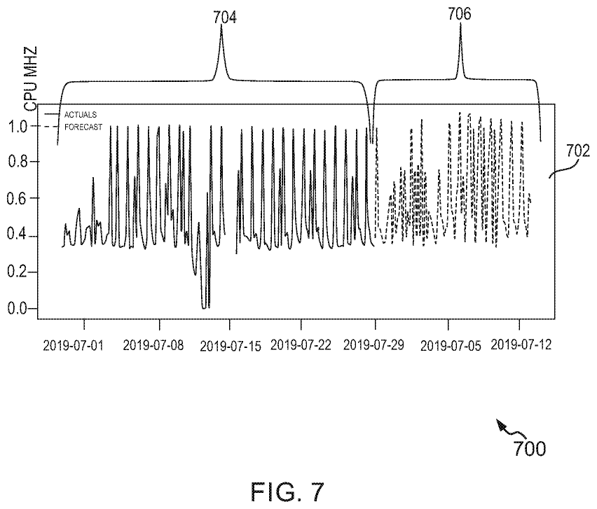

At operation 312, the neural network forecasting model is utilized to generate the forecast of upcoming resource requirements for each computing workload and server in the data center. In an embodiment, the neural network forecasting model is utilized in a service portal maintained by an organization maintaining the data center. A customer (e.g., the customer 106) can access a web page of the service portal from their computing device (e.g., the customer device 108) to view the forecast of the upcoming resource requirements for each of the computer servers and computing workloads in their data center. Further, the customer can use the forecast for efficient allocation of resources so that workload is balanced against forecasted demand A user interface depicting forecast of upcoming resource requirements of the data center is shown in FIG. 7.

FIG. 3B is a flowchart illustrating a method 350 for forecasting upcoming power requirements in an electrical grid, in accordance with an example embodiment. The operations of the method 350 may be carried out by a server such as the server 110, the system 200 or the electronic device 108. The sequence of operations of the method 350 need not to be necessarily executed in the same order as they are presented. Further, one or more operations may be grouped together and performed in form of a single step, or one operation may have several sub-steps that may be performed in parallel or in sequential manner.

In the flowchart, it is assumed that the electrical grid leverage distributed energy resources (DERs), including energy storage and loads that can be time-shifted. The DERs operate according to signals received from the electrical grid. Additionally, it is also assumed that the electrical grid and the DERs use batteries for storing energy in case the DERs are electricity generation systems.

At operation 352, a time series data associated with the electrical grid is received at regular intervals of time. Here, data depicting power generation in the electrical grid, and demand and supply of power at each load associated with the electrical grid is received. The load on the grid comes from geographies connected with the grid, such as cities, towns, villages etc., and the DERs associated with the grid. The data includes data points associated with voltage, current and power measurements of each load and power generation in the electrical grid. The received data may help in forecasting time series metric for the electrical grid which will provide the upcoming resource (power) requirement of the electrical grid.

At operation 354, the received time series data is examined to learn a mathematical model that forecasts upcoming power requirements in the electrical grid. The power requirements refer to amount of voltage, current and power required to meet the upcoming power demand in the electrical grid. The time series data examination is a statistical technique that deals with time series data. As described earlier, the time series data is a set of observations on the values that a variable takes at different times. In case of the electrical grid, the variable is the power.

At operation 356, calendar-based features are extracted from a time series database table. The time series database table is prepared from the time series data that is received at the operation 352. The time series data is first organized into the time series database table maintained in a database (e.g., the database 114). In an embodiment, the time series database table includes one or more columns and one or more rows, where one or more columns represent the one or more variables and one or more rows represent the one or more values taken by the one or more variable. In the case of electrical grid, the variables represent the power resources, such as current, voltage, and power demand.

Once the time series data is organized in the time series database table, the values taken by the variables are extracted based on calendar features. Here, the values taken by the variables represent the calendar based features. The calendar based features are numeric components extracted from a timestamp of each measurement in the time series, such as a year, a month, a day of a year, a day of a month in a solar calendar (for example, in a Gregorian calendar), a day in a lunar month, a day of a month in a lunar calendar, a day of week, a week of month, an hour and a minute. The calendar based features help in determining resource utilization cycles that the loads associated with the electrical grid follows in the past which will help in determining the time series metric that the electrical grid may follow in future.

At operation 358, the received time series data and calendar-based features are processed into machine-learning features. The time series data is processed into machine-learning features related to cyclically repeating trends in the time series data and growth/decline trends in the time series data. The cyclically repeating trends and growth/decline trends are determined based on the calendar-based features. The generated machine learning features are further imported into a neural network application which outputs a neural network forecasting model (discussed in operation 360). It will be appreciated by those skilled in the art that, any suitable neural network application may be used to perform the operations described herein.

After importing the machine learning features, it is determined whether a previously learnt time series of the electrical grid already exists in the neural network application. If it is determined that the previously learnt time series already exists, the time series data is summarized into a set of average values for each hour of the week (168 values total) and compared with previously learnt time series. If a previously learnt time series is found to be similar with current time series data, the neural network learning process starts with the neural network weights (set of average values) for the previously learnt time series as this decreases the number of epochs required to learn the new time series and create the neural network forecasting model.

At operation 360, the neural network forecasting model is developed that forecasts voltage, current and power measurements for each load associated with the electrical grid based on the received time series data. The neural network forecasting model is developed based on the machine learning features using the neural network application. The time series is summarized into a recurring cycle, for example, a set of average values for each hour of the week (168 values total) and its neural network is stored along with the summary in the database. The stored summaries are used to optimize the learning rate (in number of epochs) for new incoming time series in operation 358. In an embodiment, the neural network application is a deep neural network application.

At operation 362, the neural network forecasting model is utilized to generate the forecast of upcoming power generation at the electrical grid and power requirements for each load associated with the electrical grid. In an embodiment, the neural network forecasting model is utilized in a service portal maintained by an electricity department maintaining the electrical grid. A customer (e.g., the customer 106) can access a web page of the service portal from their computing device (e.g., the customer device 108) to view the forecast of the upcoming resource (power) requirements for each of the DER associated with the electrical grid. Further, the customer can use the forecast for storing the excess energy in batteries which may be used when demand is expected to peak. It should be noted that the FIGS. 3A and 3B represent only two examples where the developed methods and systems can be used. There are various applications of the developed methods and systems on which teachings of the present disclosure can be applied, and these are not explained separately for the sake of brevity.

FIG. 4 is a schematic representation of a user interface (UI) 400 representing a time series database table 402 maintained for a data center (e.g., the data center 102 shown in FIG. 1), in accordance with an exemplary embodiment of the present disclosure. The UI 400 displays the time series database table 402 including time series data associated with a workload executed in the data center. The time series data includes the resource usage data, such as CPU, memory and network readings for the workload.

The columns of the time series database table 402 represent the fields of the time series database table 402 and each row defines values possessed by the fields. The time series database table 402 includes fields for date on which readings are captured and represented by ‘Date’, time at which the readings are captured by ‘Time’, CPU utilization for performing the workload in megahertz represented by ‘CPU/MHz’, memory utilization for performing the workload in kilobytes represented by ‘MEM/KB’ and network utilization for performing the workload in megabits per second represented by ‘NET/Mbps’. For example, a row 404 illustrates that the time series data is captured on ‘30Jun. 2019’ at time ‘10:8:24 pm’ and the CPU utilized was ‘31.2000 MHz’, memory consumed was ‘56096.8000 KB’ and the network bandwidth consumed was ‘824.000 Mbps’ for performing the workload.

The data recorded for the workload is used to make forecasts on future resource usage for the same workload. A key point observed in the method described herein is that workloads exhibit cycles on real-world boundaries, for instance, day/night variations, week/weekend variations, end-of-month and end-of-quarter variations and so on therefore calendar based features are extracted from the time series database table 402.

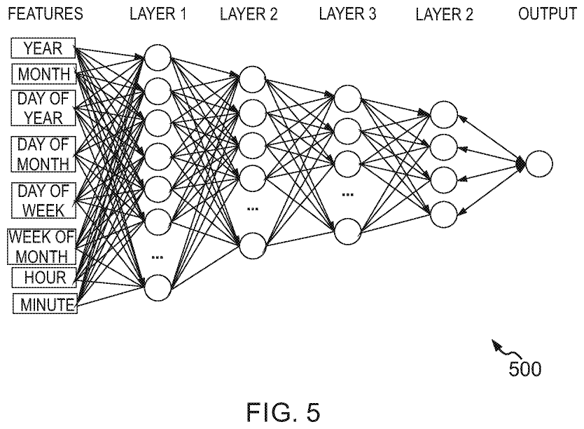

FIG. 5 is a schematic representation 500 showing importing of past resource usage values into a deep neural network, in accordance with an example embodiment. The calendar based features (values associated with resource utilization) that are extracted from a time series database table (e.g., the time series database table 402) are fed as inputs in a neural network. Subsequently, the values are analysed at a plurality of layers (Layer 1, Layer 2, Layer 3 and Layer 4) to finally produce an output. Each layer has one or more nodes and each node is connected to a statistical forecast.

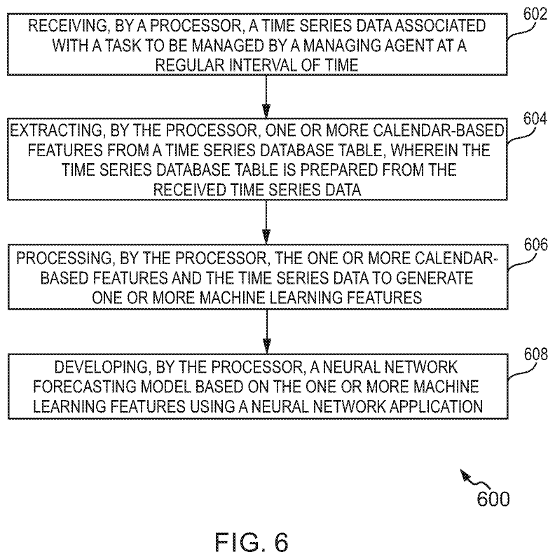

FIG. 6 is a flowchart illustrating a method 600 for upcoming values of a time series for a managing agent managing a task, in accordance with an example embodiment. The operations of the method 600 may be carried out by a server such as the server 110, the system 200 or the electronic device 108. The sequence of operations of the method 600 may not be necessarily executed in the same order as they are presented. Further, one or more operations may be grouped together and performed in form of a single step, or one operation may have several sub-steps that may be performed in parallel or in sequential manner.

At operation 602, the method 600 includes receiving, by a processor, a time series data associated with a task to be managed by a managing agent at a regular interval of time. The time series data associated with the managing agent managing a task is received at a regular interval of time, such as after every 5 sec. The time series data is a set of observations on one or more values that one or more variables take at a predefined interval. The one or more variables depend on the task to be managed by the managing agent. For example, if the task is to efficiently utilize resources of a data center, so data depicting utilization of resources of the data center while performing a computing workload will be measured. The data includes one or more values associated with one or more variables, such as values associated with CPU, RAM, network bandwidth and power utilization (variables in case of data center) when the computing workload is performed in the data center. In the current example, the data center is the managing agent and the efficient utilization of the resources of the data center is the task that is to be managed by the managing agent. It should be noted that the time interval at which the time series data will be collected is set in advance by an admin of the data center.

At operation 604, the method 600 includes extracting, by the processor, one or more calendar-based features from a time series database table, where the time series database table is prepared from the received time series data. Once the time series data is received, the time series data is first organized in the time series database table maintained in a database (e.g., the database 114). The time series database table includes one or more columns representing the one or more variables and one or more rows representing the one or more values taken by the one or more variables. Further, the one or more values taken by the one or more variables are extracted from the time series database table based on one or more calendar features. The one or more calendar features provide direct correlation with resource usage cyclicality and rising/falling trends. Such direct correlations are much easier to learn by machine learning models such as neural networks, which translate to less computational overhead for forecasting compared to brute-force methods.

The calendar based features are an average of the one or more values possessed by each variable of the one or more variables on specific calendar feature, such as a year, a month, a day of a year, a day of a month, a day of week, a week of month, an hour and a night of a day. The calendar based features help in determining resource utilization cycles that the managing agent follows in the past which will help in determining upcoming values of the time series metric that the managing agent may follow in future.

At operation 606, the method 600 includes processing, by the processor, the one or more calendar-based features and the time series data to generate one or more machine learning features. The time series data is processed into machine-learning features related to cyclically repeating trends in the time series data and growth/decline trends in the time series data. The cyclically repeating trends and growth/decline trends are determined based on the extracted one or more calendar-based features. The generated machine learning features are further imported into a neural network application which outputs a neural network forecasting model (discussed in detail in operation 608). In an embodiment, a deep neural network application is used to perform the operations described herein. It will be appreciated by those skilled in the art that, any suitable neural network application may be used to perform the operations described herein.

At operation 608, the method 600 includes developing, by the processor, a neural network forecasting model based on the one or more machine learning features using the neural network application. The neural network forecasting model is developed based on the machine learning features using the neural network application. Once the machine learning features are imported in the neural network application, it is determined whether a previously learnt time series associated with the managing agent already exists in the neural network application. If it is determined that the previously learnt time series already exists in the neural network application, the time series data is summarized into a set of average values for a predefined time interval. In an embodiment, the predefined time interval is each hour of the week so a total of 168 values are obtained after summarizing the time series data. Further, the set of average values for the predefined time interval is compared with values of the previously learnt time series for determining similarity between the previously learnt time series and the time series data. If similarity is found between the average values of the time series data and the previously learnt time series, the neural network learning process starts with the neural network weights for the previously learnt time series as this decreases the number of epochs required to learn the new time series and to create the neural network forecasting model. In an embodiment, the similarity between the previously learnt time series and the time series data is defined based on Euclidean proximity.

Once the neural network forecasting model is generated, the neural network forecasting model is used to generate a forecast of upcoming values of time series for the managing agent. The forecast of upcoming values of time series can be viewed on a webpage maintained by the managing agent. The forecast of upcoming values of time series helps in forecasting upcoming resource requirement for the managing agent and also helps in distinguishing a normal (expected) activity from an anomalous activity.

FIG. 7 is a schematic representation of a user interface (UI) 700 depicting resource requirement forecast for an upcoming computing workload in a data center (e.g. the data center 102), in accordance with an exemplary embodiment of the present disclosure. The UI 700 is presented on a computing device, such as the customer device 108 shown in FIG. 1. The UI 700 displays a graph 702 including CPU usage readings when the workload is performed in past and CPU usage reading when the workload will be performed in future by the data center.

As shown in FIG. 7, X-axis of the graph 702 denotes time and Y-axis of the graph 702 denotes CPU usage. The CPU usage readings 704 until the end of July 28^{th} are used for training a neural network and CPU usage readings 706 represent the predicted readings starting from July 29^{th} for a next couple of weeks which are generated from the trained neural network.

FIG. 8 shows a simplified block diagram of an electronic device 800 capable of implementing the various embodiments of the present disclosure. The electronic device 800 may be an example of the electronic device 108. It should be understood that the electronic device 800 as illustrated and hereinafter described is merely illustrative of one type of device and should not be taken to limit the scope of the embodiments. As such, it should be appreciated that at least some of the components described below in connection with the electronic device 800 may be optional and thus in an example embodiment may include more, less or different components than those described in connection with the example embodiment of the FIG. 8. As such, among other examples, the electronic device 800 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the electronic device 800 and supports for one or more applications programs that implement one or more of the innovative features described herein. The applications 806 may include common mobile computing applications (e.g., telephony applications, email applications, calendars, contact managers, web browsers, messaging applications such as USSD messaging or SMS messaging or SIM Tool Kit (STK) application) or any other computing application.

The illustrated electronic device 800 includes one or more memory components, for example, a non-removable memory 808 and/or a removable memory 810. The non-removable memory 808 and/or the removable memory 810 may be collectively known as database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804. The electronic device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854 for example, an accelerometer, a gyroscope, a compass, or an infrared proximity sensor for detecting the orientation or motion of the electronic device 800, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 7, or one or more operations of the flow diagram 300 and 350, and the flowchart 600 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

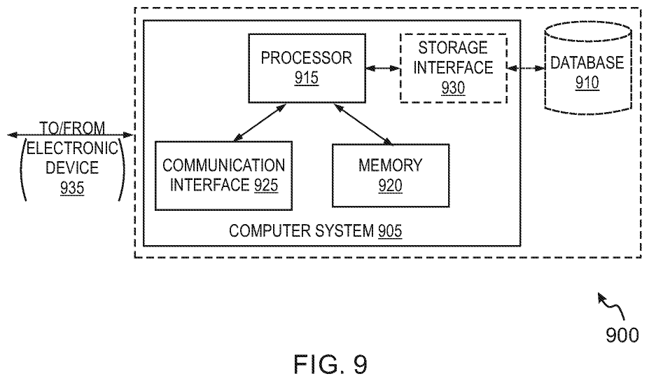

FIG. 9 is a simplified block diagram of a server system 900, in which the time series metric forecasting engine 112 may be stored, in accordance with one embodiment of the present disclosure. The server system 900 is an example of the server 110 shown and explained with reference to FIG. 1. The server system 900 includes a computer system 905 and one or more databases, such as a database 910.

The computer system 905 includes a processor 915 for executing instructions. Instructions may be stored in, for example, but not limited to, a memory 920. The processor 915 may include one or more processing units (e.g., in a multi-core configuration). The processor 915 is operatively coupled to a communication interface 925 such that the computer system 905 is capable of communicating with a remote device such as an electronic device 935. Example of the electronic device 935 may include, but is not limited to the electronic device 108 shown in FIG. 1.

The processor 915 may also be operatively coupled to the database 910. The database 910 is configured to store the time series metric forecasting engine 112 capable of forecasting upcoming values of time series which will help in forecasting upcoming resource requirement of the managing agent as explained with reference to FIGS. 1 to 7. The database 910 is any computer-operated hardware suitable for storing and/or retrieving data. The database 910 may include multiple storage units such as hard disks and/or solid-state disks in a redundant array of inexpensive disks (RAID) configuration. The database 910 may include, but not limited to, a storage area network (SAN) and/or a network attached storage (NAS) system.

In some embodiments, the database 910 is integrated within the computer system 905. For example, the computer system 905 may include one or more hard disk drives as the database 910. In other embodiments, the database 910 is external to the computer system 905 and may be accessed by the computer system 905 using a storage interface 930. The storage interface 930 is any component capable of providing the processor 915 with access to the database 910. The storage interface 930 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 915 with access to the database 910.

The memory 920 is a storage device embodied as one or more volatile memory devices, one or more non-volatile memory devices, and/or a combination of one or more volatile memory devices and non-volatile memory devices, for storing micro-contents information and instructions. The memory 920 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

Various example embodiments offer, among other benefits, techniques for establishing methods and systems for forecasting upcoming values of time series for the managing agent and thereby accurately forecast upcoming resource requirement for the managing agent which will help in efficient allocation of resources for performing an upcoming task. Further, the amount of data that needs to be hauled back from sensors at an edge of the network to core data centers is minimized as machine learning models are built at the edge. The accurate time series forecasts further used to set a normal pattern for future times which allows computationally flagging of anomalous activities and this helps in differentiating a normal activity from an anomalous activity.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus creates a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application and/or implementation without departing from the spirit or scope of the claims.

What is claimed is:

1. A method, comprising:
receiving, by a processor, a time series data associated with a task to be managed by a managing agent at a regular interval of time;
extracting, by the processor, one or more calendar-based features from a time series database table, wherein the time series database table is prepared from the received time series data;
processing, by the processor, the one or more calendar-based features and the time series data to generate one or more machine learning features; and
developing, by the processor, a neural network forecasting model based on the one or more machine learning features using a neural network application.

2. The method as claimed in claim 1, further comprising:
using, by the processor, the neural network forecasting model to generate a forecast of upcoming values of time series for the managing agent; and
displaying, by the processor, the upcoming values of time series.

3. The method as claimed in claim 1, wherein the time series data is a set of observations on one or more values that one or more variables take at a predefined interval, wherein the one or more variables depend on the task to be managed by the managing agent.

4. The method as claimed in claim 3, wherein extracting the one or more calendar-based features comprise:
organizing, by the processor, the time series data in the time series database table in which one or more columns represent the one or more variables and one or more rows represent the one or more values taken by the one or more variables; and
extracting, by the processor, the one or more values taken by the one or more variables from the time series database table based on one or more calendar features.

5. The method as claimed in claim 4, wherein the one or more calendar features comprise:
a year;
a month;
a day of year;
a day of month;
a day of week;
a week of month;
an hour; and
a minute.

6. The method as claimed in claim 1, wherein developing the neural network forecasting model comprises:
importing, by the processor, the one or more machine learning features into the neural network application.

7. The method as claimed in claim 6, wherein importing the one or more machine learning features further comprise:
determining, by the processor, whether a previously learnt time series exists in the neural network application;
upon determining that the previously learnt time series exists in the neural network application, summarizing, by the processor, the time series data into a set of average values for a predefined time interval;
comparing, by the processor, the set of average values for the predefined time interval with values of the previously learnt time series for determining similarity between the previously learnt time series and the time series data; and
upon determining similarity between average values of the time series data and the previously learnt time series, starting, by the processor, a neural network learning process with weights of the previously learnt time series.

8. The method as claimed in claim 7, wherein the predefined time interval is each hour of a week.

9. The method as claimed in claim 7, wherein the similarity between the previously learnt time series and the time series data is defined based on Euclidean proximity.

10. A server system, comprising:
a memory configured to store instructions; and
a processor configured to execute the instructions stored in the memory and thereby cause the server system to perform:
receiving a time series data associated with a task to be managed by a managing agent at a regular interval of time;
extracting one or more calendar-based features from a time series database table, wherein the time series database table is prepared from the received time series data;
processing the one or more calendar-based features and the time series data to generate one or more machine learning features; and
developing a neural network forecasting model based on the one or more machine learning features using a neural network application.

11. The server system as claimed in claim 10, wherein the processor is further configured to:
use the neural network forecasting model to generate a forecast of upcoming values of time series for the managing agent; and
display the upcoming values of time series.

12. The server system as claimed in claim 10, wherein the time series data is a set of observations on one or more values that one or more variables take at a predefined interval, wherein the one or more variables depend on the task to be managed by the managing agent.

13. The server system as claimed in claim 12, wherein for extracting the one or more calendar-based features, the processor is further configured to:
organize the time series data in the time series database table in which one or more columns represent the one or more variables and one or more rows represent the one or more values taken by the one or more variables; and
extract the one or more values taken by the one or more variables from the time series database table based on calendar features.

14. The server system as claimed in claim 13, wherein the calendar features comprise:
a year;
a month;
a day of year;
a day of month;
a day of week;
a week of month;
an hour; and
a minute.

15. The server system as claimed in claim 10, wherein for developing the neural network forecasting model, the processor is further configured to:
import the one or more machine learning features into the neural network application.

16. The server system as claimed in claim 15, wherein for importing the one or more machine learning features, the processor is further configured to:
determine whether a previously learnt time series exists in the neural network application;
upon determining, summarize the time series data into a set of average values for a predefined time interval;
compare the set of average values for the predefined time interval with values of the previously learnt time series; and
upon determining similarity between average values of the time series data and the previously learnt time series, start a neural network learning process with weights of the previously learnt time series.

17. The server system as claimed in claim 16, wherein the predefined time interval is each hour of a week.

18. A system, comprising:
a database to store time series data associated with a managing agent of one or more managing agents;
a user interface (UI) module in communication with the database, the UI module is configured to present one or more UIs for facilitating forecast of upcoming values of time series for the managing agent;
a managing agent management module in communication with the UI module and the database, the managing agent management module is configured to manage the one or more managing agents that are enrolled with the system for determining forecast of resource requirement;
a task management module in communication with the UI module and the managing agent management module, the task management module is configured to manage a task to be managed by the managing agent;
a time series metric forecasting engine in communication with the managing agent management module and the task management module, the time series metric forecasting engine is configured to forecast the upcoming values of the time series for the managing agent; and
a processing module for providing operating instructions to the UI module, the managing agent management module, the task management module and the time series metric forecasting engine.

19. The system as claimed in claim 18, wherein the UI module comprises:
an input interface for receiving data associated with each managing agent of the one or more managing agents, the data comprising information related with the task to be managed; and
an output interface for displaying the forecast of upcoming resource requirement for each managing agent.

20. The system as claimed in claim 18, wherein the time series metric forecasting engine comprises:
a time series data collecting unit for collecting the time series data associated with the managing agent at a regular interval of time;
a calendar feature extracting unit in communication with the time series data collecting unit for extracting calendar based features from the time series data; and
a neural network forecasting model development unit in communication with the time series data collecting unit and the calendar feature extracting unit for processing the time series data and the calendar based features into one or more machine learning features and then developing a neural network forecasting model from the one or more machine learning features for forecasting the upcoming values of the time series for the managing agent, wherein the neural network forecasting model is generated using the neural network application.
